(19) United States
(12) Patent Application Publication
(10) Pub. No.: US 2006/0099551 A1
(43) Pub. Date: May 11, 2006

(54) REMOVABLE TOOTH COVER

(76) Inventor: Gregory Feldman, North York, Ontario (CA)

Correspondence Address: FASTH LAW OFFICES (ROLF FASTH), 26 PINECREST PLAZA, SUITE 2, SOUTHERN PINES, NC, 28387-4301, US

(21) Appl. No.: 11/163,870

(22) Filed: Nov. 2, 2005

Related U.S. Application Data
(60) Provisional application No. 60/625,967, filed on Nov. 9, 2004.

(51) Int. Cl. A61C 5/00

(52) U.S. Cl. 433/215

(57) ABSTRACT

The present invention relates to a removable cover for upper or lower teeth comprising a U-shaped thin plastic member having a front side, back side and a top side with a chewing surface. The front side and back side extend beyond the teeth and cover part of the gum for keeping food or other elements out of space between teeth, dentures or cavities. Means for securing said U-shaped thin plastic member in place during chewing are also provided.

### FIELD OF THE INVENTION

This invention relates to a method and apparatus for protecting the teeth, dentures, gums, and space round the teeth from cluttering and harmful effects during eating, drinking, chewing. In particular the present invention relates to a covering strip to be applied over the teeth or dentures during eating, drinking, chewing and helps

decrease teeth and gums wear.

### BACKGROUND OF THE INVENTION

Mouth guards for protecting the teeth during sports are well known. See for example U.S. Pat. No. 5,816,255 or U.S. Pat. No. 5,051,476.

U.S. Pat. No. 5,462,067 describes a disposable shield device to keep food away from the teeth and gums during eating. The shield is made from a thin plastic film

U.S. Pat. No. 5,460,527 describes a dental bleaching tray.

U.S. Pat. No. 6,274,122 relates to teeth whitening strips and the like.

### BRIEF DESCRIPTION OF THE DRAWINGS

Preferred embodiments of the invention are shown in the drawings, wherein:

FIG. 1 illustrates one embodiment of a cover for teeth according to the present invention covering a set of teeth and secured to the palate using a suction effect.

FIG. 2 illustrates a section of a cover for teeth of FIG. 1 showing the chewing surface optimized for chewing.

FIG. 3 shows another embodiment of a cover for teeth according to the present invention covering a set of teeth and held in place by a flap and tightening strips.

FIG. 4 is an enlarged cross section view of the tightening strips of FIG. 3 at point A.

FIG. 5 is a view of the location of tightening strips of FIGS. 3 and 4.

FIG. 6 shows another embodiment of a cover for teeth according to the present invention for covering a set of teeth and to be held in place by a pair of straps that fit between the teeth.

### DETAILED DESCRIPTION OF THE PREFERRED EMBODIMENTS

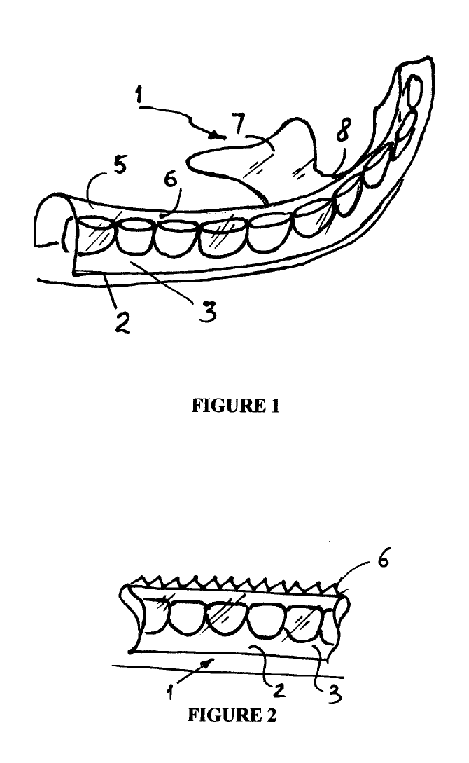

One embodiment of a cover for teeth according to the present invention is illustrated in FIG. 1 and generally indicated at 1. The cover for teeth of FIG. 1 is comprised of a U-shaped thin plastic member 2 having a front side 3, back side 4 and top side 5 with a chewing surface 6. In general one U-shaped thin plastic member 2 would be used to cover the bottom teeth and a second U-shaped thin plastic member 2 used to cover the top teeth. The front side 3 and back side 4 preferably extend beyond the teeth and cover part of the gum for keeping food or other elements out of space between teeth, dentures, cavities and etc. As shown in FIG. 2 the chewing surface 6 can be enhanced (optimized) for chewing improvement. This can be achieved by creating a special texture or/and by creating a special coating.

In order to shape the U-shaped thin plastic member 2 to the individual person's teeth the best results can be achieved using custom fabrication. The process preferably begins by making a denture model by taking impressions from the teeth and creating

Casts from which a denture model is made. Blank U-shaped thin plastic members 2 can be provided in different sizes to fit different sizes on mouths and teeth as many as needed.

A blank U-shaped thin plastic member 2 is preferably placed over a denture model of a particular person, and then custom formed using molding, pressing, vacuum formation or similar process. The denture models are created by taking impressions for the upper and/or lower jaws.

The U-shaped thin plastic member 2 can be held in place by a number of different methods either mechanical fastening means, using adhesives, using the ability of some materials to stick to wet surfaces—capillary effect—, by suction or vacuum or any other suitable method. The present invention is not limited to any particular method. In FIG. 1 a special wing member 7 attached to the edge 8 of the back side 3 of U-shaped thin plastic member 2 helps secure the tooth cover 1 in place using suction effect to the palate.

The U-shaped thin plastic member 2 should be made from materials approved by health authorities and most likely it will be a polymer material. It should be strong enough to stand against all the actions during food intake, drinking, smoking and so on for at least one eating session.

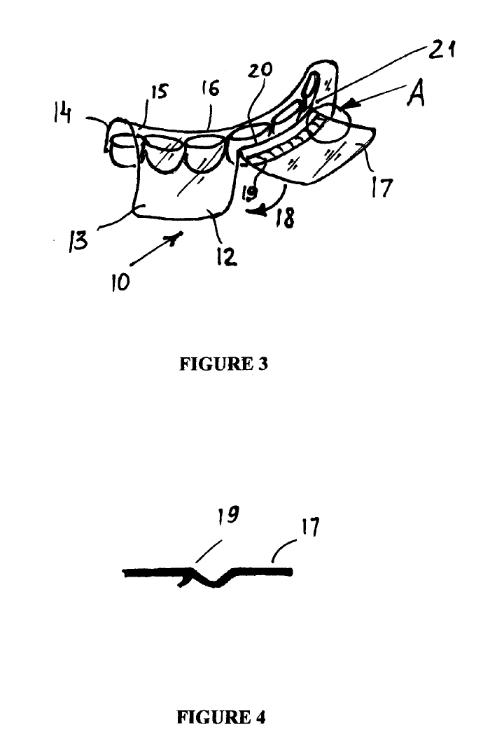

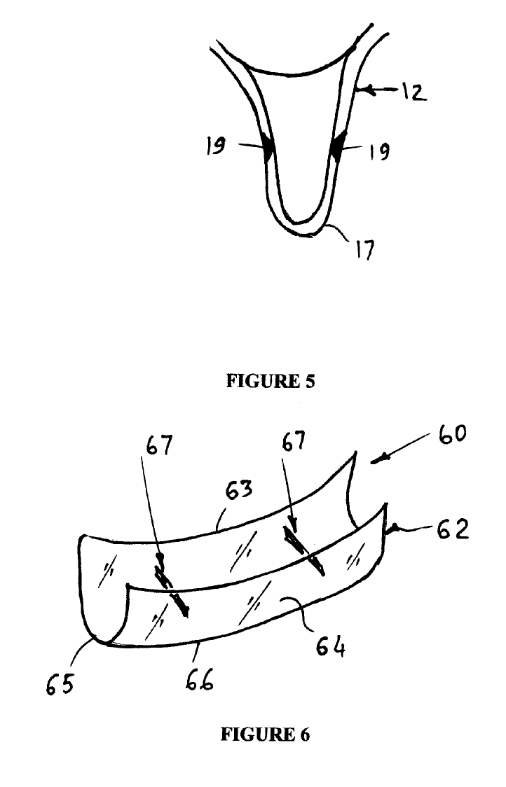

Having regard to FIGS. 3-5 another embodiment of a cover for teeth according to the present invention is generally indicated at 10. The cover for teeth of FIG. 3 is comprised of a U-shaped thin plastic member 12 having a front side 13, back side 14 and top side 15 with a chewing surface 16. A flap 17 centrally located on the front side 13 is pushed towards the teeth as indicated by arrow 18. The flap 17 is equipped with a tightening strip 19 along the edge of the flap 17 adjacent the point of connection 20 with the remaining portion 21 of the front side 13. When flap 17 is pushed towards the teeth the tightening strip 19 locks flap 17 in the closed position against the teeth. FIG. 4 shows an enlarged view in cross section of one embodiment of the tightening strip 19 through point A in FIG. 3. FIG. 5 shows a top plan view of the tooth cover of FIG. 3 and indicating the tightening strip locations 22.

Having regard to FIG. 6 another embodiment of a cover for teeth according to the present invention is generally indicated at 60. The cover for teeth of FIG. 6 is comprised of a U-shaped thin plastic member 62 having a front side 63, back side 64 and top side 65 with a chewing surface 66. A pair of thin straps 67 are placed between the front side 63 and the back side 64 and are adapted to fit between adjacent teeth to help secure the tooth cover 60 in place.

Since everything in a mouth is wet this can be used to secure teeth cover, making the U-shaped thin plastic member from a material capable of sticking to wet surfaces, using, for example, capillary effect.

Teeth cover is a device for preventing cluttering the space around teeth and cavities by food elements or by other stuff taken into mouth during food, drugs intake and as well drinking liquids, chewing gums, smoking, rinsing by liquids and so on.

While the above description has shown the various embodiments of a cover for teeth according to the present invention orientated for use with the bottom teeth a similar cover is used to cover the top teeth. In the case of the top teeth, the U-shaped thin plastic member has having a front side, back side and a bottom side with a chewing surface rather than a top side.

The tooth cover of the present invention is also useful for decreasing mechanical, chemical, temperature, and etc. harmful actions (effects) on teeth, gums and other tissues in the mouth. This invention protects the teeth, dentures, gums, and space round the teeth from cluttering and harmful effects during eating, drinking, chewing

While the tooth cover of the present invention has a similar purpose as shield device of U.S. Pat. No. 5,462,067, the construction of the present invention is different resulting in improved performance.

Although various preferred embodiments of the present invention have been described herein in detail, it will be appreciated by those skilled in the art, that variations may be made thereto without departing from the spirit of the invention or the scope of the appended claims.

What is claimed is:

1. A removable cover for upper or lower teeth comprising a U-shaped thin plastic member having a front side, back side and a top side with a chewing surface wherein said front side and back side extend beyond the teeth and cover part of the gum for keeping food or other elements out of space between teeth, dentures or cavities and means for securing said U-shaped thin plastic member in place during chewing.

2. A removable cover for upper or lower teeth according to claim 1 wherein the chewing surface is enhanced for chewing improvement.

3. A removable cover for upper or lower teeth according to claim 1 wherein said means for securing
said U-shaped thin plastic member in place during
chewing is selected from the group consisting of mechanical fastening means, adhesives, using the ability of some materials to stick to wet surfaces—capillary effect—, by suction or vacuum or any other suitable method.
